(19) United States
(12) Patent Application Publication
(10) Pub. No.: US 2013/0155207 A1
(43) Pub. Date: Jun. 20, 2013

(54) SYSTEM AND METHOD FOR AUTOMATICALLY CONTROLLING A VIDEO PRESENTATION

(71) Applicants: Joseph M. Freund, Fogelsville, PA (US); Roger A. Fratti, Mohnton, PA (US); Sailesh M. Merchant, Macungie, PA (US); Sujal D. Shah, Fogelsville, PA (US)

(72) Inventors: Joseph M. Freund, Fogelsville, PA (US); Roger A. Fratti, Mohnton, PA (US); Sailesh M. Merchant, Macungie, PA (US); Sujal D. Shah, Fogelsville, PA (US)

(21) Appl. No.: 13/327,559

(22) Filed: Dec. 15, 2011

(51) Int. Cl. H04N 13/04

(52) U.S. Cl. 348/54; 348/E13.036

(57) ABSTRACT

A system for, and method of automatically controlling a video presentation and 3D glasses incorporating the system or the method. In one embodiment, the system is configured to sense whether a viewer is wearing glasses and transmit a signal to the video source if the viewer is not wearing the glasses. In another embodiment, the system is configured to sense whether the viewer is watching the video presentation and transmit a signal to the video source if the viewer is not watching the video presentation.

### TECHNICAL FIELD

This application is directed, in general, to audiovisual broadcast and playback devices and, more specifically, to a system and method for automatically controlling a video presentation.

### BACKGROUND

Three-dimensional (3D) video finally appears ready to deliver on its more than half century long promise of enhancing the reality of video presentations such as movies and television broadcasts. More theatrical movie and concert releases are in 3D, and 3D for the home has taken a giant leap forward with the advent of 3D capable displays, primarily of the liquid crystal display (LCD) type. Sources of 3D for the home include real-time sources such as a local television station, television broadcast network, cable provider, satellite provider or Internet provider and prerecorded sources such as a digital video recorder (DVR), Blu-Ray® disc (BD), Digital Versatile Disc (DVD), videotape, video file or Internet video stream may provide.

While a few, rather expensive, 3D displays do not require 3D glasses, the vast majority do. Thus, whether the particular process employed to produce the 3D effect is anaglyphic (e.g., red-green), polarization, or, far more commonly, alternating field, a viewer (i.e., the person watching the 3D video presentation) is required to wear 3D glasses to enjoy the 3D effect. If the viewer does not wear the glasses, he loses the 3D effect.

### SUMMARY

One aspect provides a system for automatically controlling a video presentation. In one embodiment, the system includes: (1) a detector configured to sense whether a viewer is wearing glasses and (2) a transmitter coupled to the detector and configured to transmit a first signal to a video source of the video presentation if the viewer is wearing the glasses and configured to transmit a second signal to the video source if the viewer is not wearing the glasses. In another embodiment, the system includes: (1) a detector configured to sense whether a viewer is watching the video presentation and (2) a transmitter coupled to the detector and configured to transmit a first signal to a video source of the video presentation if the viewer is watching the video presentation and configured to transmit a second signal to the video source if the viewer is not watching the video presentation.

Another aspect provides a method of automatically controlling a video presentation. In one embodiment, the method includes: (1) sensing whether a viewer is wearing glasses, (2) transmitting a first signal to a video source of the video presentation if the viewer is wearing the glasses and (3) transmitting a second signal to the video source if the viewer is not wearing the glasses. In another embodiment, the method includes: (1) sensing whether a viewer is watching the video presentation, (2) transmitting a first signal to a video source of the video presentation if the viewer is watching the video presentation and (3) transmitting a second signal to the video source if the viewer is not watching the video presentation.

Yet another aspect provides 3D glasses. In one embodiment, the 3D glasses include: (1) a detector integral to the 3D viewing classes and configured to sense whether a viewer is wearing the 3D glasses and (2) a transmitter integral to the 3D glasses, coupled to the detector and configured to transmit a first signal to a video source of the 3D video presentation if the viewer is wearing the 3D glasses and configured to transmit a second signal to the video source if the viewer is not wearing the 3D glasses. In another embodiment, the 3D glasses include: (1) a detector integral to the 3D viewing classes and configured to sense whether a viewer is watching a video presentation and (2) a transmitter integral to the 3D glasses, coupled to the detector and configured to transmit a first signal to a video source of the 3D video presentation if the viewer is watching the video presentation and configured to transmit a second signal to the video source if the viewer is not watching the video presentation.

### BRIEF DESCRIPTION

Reference is now made to the following descriptions taken in conjunction with the accompanying drawings, in which:

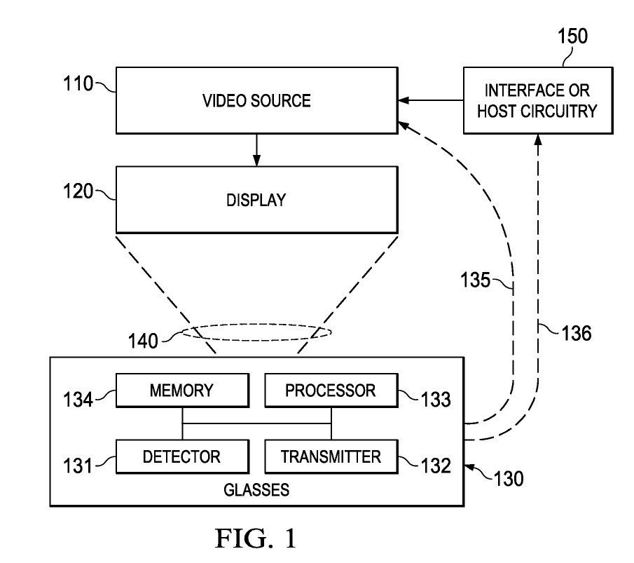

FIG. 1 is a highly schematic diagram of one embodiment of a system for automatically controlling a video presentation; and

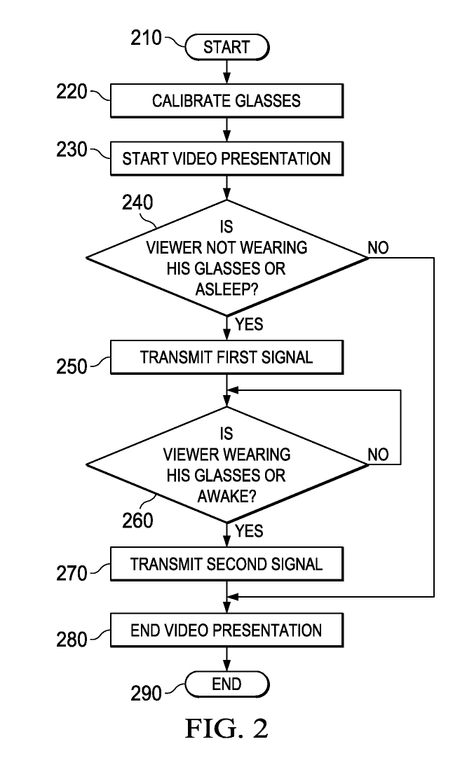

FIG. 2 is a flow diagram of one embodiment of a method of automatically controlling a video presentation.

### DETAILED DESCRIPTION

Masculine pronouns are used herein, but include the feminine. As stated above, the vast majority of 3D displays require 3D glasses. The viewer of such a display loses the 3D effect if he does not wear the glasses.

As desirable as it may be to the viewer to continue the 3D effect, it is realized herein that various circumstances may nonetheless urge the viewer to interrupt it. For example, the viewer may experience some eye fatigue and want to alleviate it by removing the glasses to rub his eyes and focus on other objects for awhile. The viewer may want to take a bathroom or food break or converse with another person. The person may simply be done with viewing for the time being. These and a host of other eventualities may cause the viewer to want to have the 3D presentation pause while his glasses are removed so he does not miss some part of it.

Currently, a viewer is forced to interrupt the 3D presentation manually, usually by pressing a pause or stop button on a video source (e.g., a DVR, BD, DVD or video disc player, digital television (DTV), videotape player, computer media player or Internet video stream player or receiver) or its remote control. Then, when the viewer is ready to resume the 3D presentation, he is forced to resume the 3D presentation manually, usually by pressing the play button or again pressing the pause button on the video source or its remote control. This manual intervention required of the viewer is not only annoying to a person of normal sensibilities, it also leads to the possibility that the viewer will miss short portions of the 3D presentation (if he interrupts the 3D presentation too late or resumes it too early) or wear his 3D glasses unnecessarily (if he interrupts the 3D presentation too early or resumes it too late).

Disclosed herein are various embodiments of a system and method for automatically pausing a video presentation. The system and method are associated with glasses. In some embodiments, the system and method are generally configured to determine whether or not a viewer is wearing the glasses. If the viewer is not wearing the glasses and a video presentation is playing, the system and method automatically cause the video presentation to be interrupted. If the viewer is wearing the glasses and a video presentation is interrupted, the system and method automatically cause the video presentation to be resumed. In one more specific embodiment, the system and method are generally configured to determine whether the viewer is putting on or taking off the glasses and are therefore configured to sense a proximity of at least some part of the viewer's head. In various embodiments to be illustrated and described, the system and method employ a proximity sensor such as a mechanical switch or an ultrasonic detector for such purpose. In still further embodiments, the system and method are generally configured to determine if the viewer's eyes are open and are configured to sense a reflectivity of at least one of the viewer's eyes. In various embodiments to be illustrated and described, the system and method employ a reflectivity sensor (e.g., a photodetector) for such purpose. In other embodiments, the detector includes a tilt sensor (e.g., a micro-electromechanical system, or MEMS, device) configured to sense whether or not the glasses are in a normal viewing orientation (perhaps indicating whether or not the viewer's head is tilted up or down, often an indication that the viewer is napping).

In certain embodiments, the system and method cause a first signal to be transmitted to a source of the video presentation if said viewer is wearing said glasses and transmit a second signal to the source of the video presentation if the viewer is not wearing the glasses. In some embodiments, the first and second signals are identical and toggle a play/pause function on the video source. In alternative embodiments, the first and second signals differ from one another and trigger play and stop functions.

In some embodiments, the system and method cause optical signals to be transmitted to the video source. In some of these embodiments, the system and method emulate a conventional optical remote control. In alternative embodiments, the system and method cause radio-frequency (RF) signals to be transmitted to the video source. In some of these embodiments, the system and method emulate a conventional RF remote control. In still further alternative embodiments, the system and method cause signals to be transmitted to interface or host circuitry that is itself connected to a video source. In one embodiment, the interface or host circuitry manages some functions of the system or the method, perhaps relating to calibration. In another embodiment, the interface or host circuitry provides an extended range for wireless (optical or RF) signal transmission.

In certain of the embodiments of the system and method, the video presentations are 3D video presentations, and the glasses of those embodiments are 3D glasses. 3D video presentations are a significant application for glasses and therefore the system and method disclosed herein. However, they are not the only application. For example, viewers with macular degeneration may employ therapeutic glasses to watch video presentations to protect his eyes from excess light or allow them better to focus his eyes. The system and method disclosed herein may operate with such therapeutic glasses to control the interruption and resumption of 3D or 2D video presentations. As another example, the viewer may be driving an automobile, and the video presentation may be the viewer's view out of the windshield of the automobile, wherein the automobile lends a dynamicity to the viewer's view. The system and method herein may operate with such glasses to control the interruption and resumption of normal operation of the automobile (e.g., by sounding an alarm or disabling the accelerator) based on the viewer's wearing of the glasses or the status of the viewer's eyes (i.e., open or closed). Thus, in the context, the automobile constitutes the video source of the video presentation in that the movement of the automobile lends dynamicity to the viewer's view out of the windshield, and the transmitter coupled to the detector is configured to transmit a first signal to the automobile (as the video source) to interrupt the video presentation.

In certain other embodiments, the system and method are configured to cause a video presentation to be interrupted or resumed by transmitting a signal to a video source associated with the display on which the video presentation is formed. In various embodiments, the video source is selected from the group consisting of a DVR (e.g., an off-air DVR, a cable television DVR or a satellite television DVR), a DTV, a video disc or video tape player, a computer media player or an Internet video stream player or receiver). Those skilled in the pertinent art will understand, however, that any device capable of controlling the display of a video presentation falls within the broad scope of the invention.

In various embodiments to be illustrated and described, the system and method are incorporated into the glasses themselves. In more specific of these embodiments, the system and method are associated with the frame front or one or both endpieces.

FIG. 1 is a highly schematic diagram of one embodiment of a system for automatically controlling a video presentation. A video source 110 is configured to function as the source of a video presentation. In various embodiments, the video source takes the form of: a DVR, a DTV, a video disc player, a video tape player, a computer media player or an Internet video stream player. A display 120 is coupled to the video source 110 and is configured to form a video image of the video presentation. The display 120 may have an integral screen configured to display the image. The display 120 may alternatively be configured project the image on a surface separate from the display 120.

The illustrated embodiment of the system is integral with glasses 130, which, in one embodiment, are 3D glasses. The illustrated embodiment of the system includes a detector 131, a transmitter 132, a processor 133 and memory 134. An unreferenced bus couples the detector 131, the transmitter 132, the processor 133 and the memory 134 for communication therebetween. A viewer (not shown) wears and peers through the glasses at the image formed by the display 120. Broken lines 140 schematically represent the field of view of a viewer peering through the glasses at the image formed by the display 120.

In the embodiment of FIG. 1, the detector 131 is configured to sense whether the viewer is wearing the glasses 130. In the embodiment of FIG. 1, the transmitter 132 is configured to transmit a first signal to the video source 110 if the viewer is wearing the glasses 130. The transmitter 132 is further configured to transmit a second signal to the video source 110 if the viewer is not wearing the glasses 130. FIG. 1 shows two alternative embodiments by which the transmitter 132 may transmit the first signal and the second signal. In a first alternative embodiment, the transmitter 132 transmits the first signal and the second signal directly to the video source 110, as a first broken-line arrow 135 indicates. In a second alternative embodiment, the transmitter 132 transmits the first signal and the second signal to interface or host circuitry 150, which then provides appropriate corresponding signals to the video source 110. A second broken-line arrow 136 indicates this second alternative embodiment.

With respect to the first alternative embodiment, the transmitter 132 may be configured to emulate a conventional optical or RF remote control, e.g., for a DVR or a DTV, or a wireless keyboard for a computer. The video source 110 receives the first and second signals as from a conventional remote control. With respect to the second alternative embodiment, the interface and host circuitry 150 may communicate with the detector 131, the transmitter 132, the processor 133 and the memory 134 in any conventional or later-developed manner with the system and communicate with the video source 110 by emulating a conventional remote control or by means of a cable. In the second alternative embodiment, the interface or host circuitry 150 manages some functions of the system and therefore may contain its own processor, memory or other suitable circuitry for communicating and processing data. In one embodiment, the interface or host circuitry 150 is configured to provides a range for wireless signal transmission that is greater than a conventional range might otherwise be. In another embodiment, the interface or host circuitry 150 is configured to cooperate with the detector 131, the transmitter 132, the processor 133 and the memory 134 to calibrate the detector 131 as will now be described.

In the illustrated embodiment, the detector 131 includes a reflectivity sensor (e.g., a photodetector) and may include multiple reflectivity sensors. In one specific embodiment, the detector 131 is calibrated as follows. First, the viewer puts the glasses on, typically before the video presentation begins. Then, the viewer presses a button (e.g., on the glasses 130 or on the interface or host circuitry 150) to initiate a calibration process. In an alternative embodiment, the calibration process begins automatically (without any viewer initiation) whenever the viewer puts on the glasses while a video presentation is not in progress. In the calibration process, the processor 133 or a processor in the interface or host circuitry 150 causes the detector 131 to make some reflectivity measurements. The reflectivity measurements are then stored in the memory 134 or memory in the interface or host circuitry 150 and thereafter serve as a baseline of reflectivity conditions prevailing while the viewer is wearing the glasses 130. One embodiment of the calibration process employs the display 120 or another indicator to prompt the viewer to take several actions. The reflectivity measurements may include a first set of measurements taken after the viewer has been prompted to wear the glasses and open both of his eyes as if viewing a video presentation. The reflectivity measurements may also include a second set of measurements taken after the viewer has been prompted to keep the glasses on but close both of his eyes as if he has fallen asleep during a video presentation. The reflectivity measurements may further include a third set of measurements taken after the viewer has been prompted to remove the glasses temporarily as if he has taken a break from viewing.

Multiple measurements could be made for each set and averaged to obtain a more moderate value. In this embodiment, with the three sets of measurements made and stored, the video presentation can begin. Other algorithms for improving the accuracy of the reflectivity measurement could be employed to measure the reflectivity profile, such as multiple detectors in the glasses. The sum of the reflectivities from all of the detectors would provide the total reflectivity for a given measurement, improving accuracy and precision of the reflectivity measurements.

The stored reflectivity measurements are then used to allow the system to monitor changes, in real time, in the reflectivity that occur as the viewer is watching the video presentation. If the viewer removes the glasses, the change in reflectivity the processor 133 is configured to compare and interpret the resulting change in reflectivity to indicate that the viewer had removed the glasses and prompt the transmitter 132 to cause the video presentation to be interrupted. If the viewer then puts the glasses back on, the resulting change in reflectivity would indicate that the video presentation should be resumed. If the viewer were to fall asleep while the video presentation is playing, the processor 133 is configured to compare and interpret the resulting change in reflectivity to indicate that the viewer's eyes are closed and prompt the transmitter 132 to cause the video presentation to be interrupted. If the viewer then wakes up, the resulting change in reflectivity would indicate that the video presentation should be resumed.

The real-time processing of the measurements of reflectivity made by the detector or detectors in the glasses could be compensated for changes in the reflectivity profile during playback, perhaps caused by stray light from the video presentation itself. This would provide a more accurate indication of when the viewer removes the glasses, puts the glasses back on or falls asleep. A delay can also be incorporated so that when a viewer wakes up, the video presentation is not resumed until after the delay, giving the viewer time to reorient himself. The video presentation can also be resumed at a point that is a certain length of time before it was interrupted to allow the viewer to re-orient himself.

FIG. 2 is a flow diagram of one embodiment of a method of automatically controlling a video presentation. The method begins in a start step 210. In a step 220, the video glasses are calibrated. In a step 230, a video presentation is started. In a decisional step 240 it is determined whether or not the viewer is not wearing his glasses or asleep. If not, the decisional step 240 is repeated, perhaps after some delay. If the viewer is not wearing his glasses or asleep, a first signal is transmitted in a step 250. In a decisional step 260 it is determined whether or not the viewer is wearing his glasses or awake. If not, the decisional step 260 is repeated, perhaps after some delay. If the viewer is wearing his glasses or awake, a second signal is transmitted in a step 270, and the decisional step 240 is repeated, perhaps after some delay. Eventually the video presentation ends in a step 280. The method ends in a step 290.

Those skilled in the art to which this application relates will appreciate that other and further additions, deletions, substitutions and modifications may be made to the described embodiments.

What is claimed is:

1. A system for automatically controlling a video presentation, comprising:
a detector configured to sense whether a viewer is wearing glasses; and
a transmitter coupled to said detector and configured to transmit a first signal to a video source of said video presentation if said viewer is wearing said glasses and configured to transmit a second signal to said video source if said viewer is not wearing said glasses.

2. The system as recited in claim 1 wherein said video presentation is a 3D video presentation and said glasses are 3D glasses.

3. The system as recited in claim 1 wherein said first and second signals are optical signals transmittable to interface or host circuitry associated with said video source.

4. The system as recited in claim 1 further comprising a processor configured to execute a calibration routine to calibrate said detector.

5. The system as recited in claim 1 wherein said video source is selected from the group consisting of:
a DVR,
a DTV,
a video disc player,
a video tape player,
a computer media player,
an Internet video stream player, and
an automobile.

6. A method of automatically controlling a video presentation, comprising:
sensing whether a viewer is wearing glasses;
transmitting a first signal to a video source of said video presentation if said viewer is wearing said glasses; and
transmitting a second signal to said video source if said viewer is not wearing said glasses.

7. The method as recited in claim 6 wherein said video presentation is a 3D video presentation and said glasses are 3D glasses.

8. The method as recited in claim 6 wherein said first and second signals are optical signals, said method further comprising transmitting said first and second signals to interface or host circuitry associated with said video source.

9. The method as recited in claim 6 further comprising executing a calibration routine to calibrate said detector.

10. The method as recited in claim 6 wherein said video source is selected from the group consisting of:
a DVR,
a DTV,
a video disc player,
a video tape player,
a computer media player,
an Internet video stream player, and
an automobile.

11. 3D glasses, comprising:
a detector integral to said 3D viewing classes and configured to sense whether a viewer is wearing said 3D glasses; and
a transmitter integral with said 3D glasses, coupled to said detector and configured to transmit a first signal to a video source of said 3D video presentation if said viewer is wearing said 3D glasses and configured to transmit a second signal to said video source if said viewer is not wearing said 3D glasses.

12. The 3D glasses as recited in claim 11 wherein said detector is associated with a frame front of said 3D glasses.

13. The 3D glasses as recited in claim 11 wherein said first signal and said second signal toggle a play/pause function on said video source.

14. The 3D glasses as recited in claim 11 wherein said first and second signals are optical signals transmittable to interface or host circuitry associated with said video source.

15. The 3D glasses as recited in claim 11 further comprising a processor integral with said 3D glasses and configured to execute a calibration routine to calibrate said detector.

16. A system for automatically controlling a video presentation, comprising:
a detector configured to sense whether a viewer is watching said video presentation; and
a transmitter coupled to said detector and configured to transmit a first signal to a video source of said video presentation if said viewer is watching said video presentation and configured to transmit a second signal to said video source if said viewer is not watching said video presentation.

17. The system as recited in claim 16 wherein said video presentation is a 3D video presentation and said glasses are 3D glasses.

18. The system as recited in claim 16 wherein said first and second signals are optical signals transmittable to interface or host circuitry associated with said video source.

19. The system as recited in claim 16 wherein said detector includes one of:
a reflectivity sensor, and
a tilt sensor.

20. The system as recited in claim 16 wherein said video source is selected from the group consisting of:
a DVR,
a DTV,
a video disc player,
a video tape player,
a computer media player,
an Internet video stream player, and
an automobile.

21. A method of automatically controlling a video presentation, comprising:
sensing whether a viewer is watching said video presentation;
transmitting a first signal to a video source of said video presentation if said viewer is watching said video presentation; and
transmitting a second signal to said video source if said viewer is not watching said video presentation.

22. The method as recited in claim 21 wherein said video presentation is a 3D video presentation and said glasses are 3D glasses.

23. The method as recited in claim 21 wherein said first and second signals are optical signals, said method further comprising transmitting said first and second signals to interface or host circuitry associated with said video source.

24. The method as recited in claim 21 wherein said detector includes one of:
a reflectivity sensor; and
a tilt sensor.

25. The method as recited in claim 21 wherein said video source is selected from the group consisting of:
a DVR,
a DTV,
a video disc player,
a video tape player,
a computer media player,
an Internet video stream player, and
an automobile.

26. 3D glasses, comprising:
a detector integral with said 3D viewing glasses and configured to sense whether a viewer is watching a video presentation; and
a transmitter integral with said 3D glasses, coupled to said detector and configured to transmit a first signal to a video source of said 3D video presentation if said viewer is watching said video presentation and configured to transmit a second signal to said video source if said viewer is not watching said video presentation.

27. The 3D glasses as recited in claim 26 wherein said detector is associated with a frame front of said 3D glasses.

28. The 3D glasses as recited in claim 26 wherein said first signal and said second signal toggle a play/pause function on said video source.

29. The 3D glasses as recited in claim 26 wherein said first and second signals are optical signals transmittable to interface or host circuitry associated with said video source.

30. The 3D glasses as recited in claim 26 further comprising a processor integral with said 3D glasses and configured to execute a calibration routine to calibrate said detector.
